(19) United States
(12) Patent Application Publication
(10) Pub. No.: US 2012/0208445 A1
(43) Pub. Date: Aug. 16, 2012

(54) AIR-CORE COIL WINDING FOR HVAC BLOWER

(75) Inventors: Andreas Schiel, Gernsbach-Lautenbach (DE); Wolfgang Krauth, Achern-Sasbachried (DE); Matthias Ludwig, Sinzheim (DE)

(73) Assignee: ROBERT BOSCH GMBH, Stuttgart (DE)

(21) Appl. No.: 13/388,916

(22) PCT Filed: Jun. 4, 2010
(86) PCT No.: PCT/EP10/57809

§ 371 Date: Apr. 23, 2012

(30) Foreign Application Priority Data
Aug. 4, 2009 (DE) 10 2009 028 196.7

(51) Int. Cl. B60H 1/00; F04B 35/04

(52) U.S. Cl. 454/143; 417/410.1

(57) ABSTRACT

The invention relates to a fan motor in a ventilator for an interior ventilation system of a motor vehicle, comprising a first part having a plurality of radially aligned coils and a second part rotatably supported relative to the first part and having a plurality of radially aligned permanent magnets, wherein a concentric ring gap is formed between coils of the first part and permanent magnets of the second part, and the coils are air-core coils.

### BACKGROUND OF THE INVENTION

Mechanically or electrically commutated electric motors are normally used, corresponding to the desired blower power, for electrically driving fan impellors in HVAC (“heating, ventilating and air conditioning”) installations (referred to in the following text as ventilation installations). In this case, one part of the electric motor, for example the stator, is fitted with a number of coils, and the other part, for example the rotor, is fitted with a number of permanent magnets. The two parts are borne such that they can rotate with respect to one another, and the coils and the permanent magnets are arranged on different sides of a concentric annular gap. The coils are wound around cores, which are integrated with an annular magnetic flux element which guides the magnetic flux between the coils. In practice, a hollow-cylindrical flux element, for example in the form of a stack of stamped laminate parts, is used for this purpose. The flux element has radial slots, with the turns of a coil passing through adjacent slots, such that the area which is surrounded by the turns is filled by a section of the flux element, which acts as a ferromagnetic coil core. The coil is manufactured from a non-ferromagnetic material, for example copper wire.

When the rotor rotates with respect to the stator, a ferromagnetic section (the coil core) and a non-ferromagnetic section (the coil) of the stator are alternately opposite a permanent magnet on the rotor. This results in permanently alternating forces acting between the rotor and the stator during rotation, thus allowing the rotor to be accelerated or braked with respect to the stator, and this adversely affects smooth running of the rotor. The frequency of the smooth-running fluctuation resulting from this is dependent on the rotation speed of the rotor and the number of coils along the circumference of the stator. This means that narrow bandwidth noise can occur during operation of the described fan motor, and can be perceived as howling or whistling. This noise can propagate through the ventilation installation in the motor vehicle, and occupants can find it to be unpleasant. The noise can also interact with further oscillations, which, for example, can also provoke harmonics, superimposed noises and beat frequencies, which are audible in the interior of the motor vehicle and lead to increased noise stress.

In the past, attempts have been made to counteract such noise development by damping the excitation or by reducing the electromagnetic forces. However, this has led to fan motors which had a large mass with respect to their performance class. This is undesirable for reasons relating to handling, production and consumption of resources during production.

### SUMMARY OF THE INVENTION

The invention is therefore based on the object of specifying a fan motor which provides good smooth running with a low mass, as a result of which the fan motor produces little noise.

According to a first aspect of the invention, a fan for an interior ventilation installation for a motor vehicle comprises a fan motor which comprises a first part having a multiplicity of radially aligned coils and a second part, which is borne such that it can rotate with respect to the first part and has a multiplicity of radially aligned permanent magnets, with a concentric annular gap being formed between coils on the first part and permanent magnets on the second part, and the coils being air-cored coils.

The use of air-cored coils avoids a ferromagnetic element of a part of the fan motor cyclically entering a magnetic field of the other part of the fan motor during operation, and leaving it again. Smooth-running fluctuations caused by an interaction such as this in a conventional fan motor therefore do not occur, and for the first time there is no noise at all caused by such smooth-running fluctuations. Furthermore, the coreless air-cored coils have considerably less hysteresis than coils wound around a ferromagnetic core.

The fan motor of the fan may comprise a first magnetic flux element for magnetic coupling of the coils on their side facing away from the annular gap. The first magnetic flux element closes the magnetic lines of force of adjacent coils which are being operated, and thus increases an effective magnetic force and, in consequence, an efficiency of the fan motor.

The turns of the coils may rest on the first magnetic flux element in the axial direction. Although this limits the maximum number of turns for each of the coils, because sections of all the turns have to be located alongside one another and only a restricted external circumference of the flux element is available for making contact with the turns, each of the turns is, however, at the same time at the shortest possible distance from the annular gap which separates the turns from the permanent magnets on the other part of the fan motor. This embodiment can therefore further increase the efficiency of the fan motor.

The fan motor of the fan may furthermore comprise a second magnetic flux element for magnetic coupling of the permanent magnets on the side facing away from the annular gap. Like the first magnetic flux element, the second magnetic flux element is used to guide magnetic lines of force, and therefore in the end to increase the efficiency of the fan motor.

The first part of the fan motor of the fan may be a stator, and the second part may be a rotor, which surrounds the stator. A fan motor such as this is known as an external rotor. The permanent magnets are fitted radially on the outside on the rotor, in order to maximize a rotating mass of the external rotor. There is no need for a mechanical commutator because the coils which are arranged on the stator cannot move with respect to an attachment element of the fan motor, to which the electrical connections of the fan motor are fitted.

In addition to the fan motor, the fan may comprise a fan impellor which is connected to the rotor of the fan motor. By way of example, it may be a radial or axial fan impellor. In one refinement, the fan impellor is half-axial and comprises both suction blades for sucking air in axially, and outlet-flow blades for the air which has been sucked in to flow out radially. A deflection element guides the air which has been sucked in to the outlet-flow blades, and at the same time restricts the flow area of the air in an axial direction. The deflection element may be designed to be radially-symmetrically concave. The fan motor with an external rotor may be arranged on the concave side of the deflection element, facing away from the blades of the fan, thus resulting in particularly good utilization of the available installation space. This makes it possible to produce a compact fan in particular with a short length in the axial direction.

Furthermore, the fan motor of the fan may comprise a winding former for fixing the first magnetic flux element. The winding carrier may furthermore be fitted with the windings of coils of the fan motor, thus resulting in a stator assembly which can be handled separately and can be produced at low cost.

The winding former may comprise two axially arranged parts. By way of example, the two parts may be shaped such that they bear the first magnetic flux element axially and radially after being joined together axially. After being joined together, the winding on the coils can be fitted to the winding former. The two parts of the winding former may be congruent, thus making it possible to save further production costs during mass production.

Each part of the winding former may comprise a projection for fixing one turn of one of the coils. Projections which are opposite one another in the axial direction may be used to bear a plurality of turns of one coil. The two parts of the winding former are connected to one another by the turns, holding the first magnetic flux element in place such that it cannot move.

Finally, the fan motor of the fan may comprise a control circuit, which is connected to the coils, for rotation-speed control without a sensor, based on excitation of the coil through which no current is flowing.

According to a second aspect, a motor vehicle comprises an interior ventilation installation having a fan as above.

### BRIEF DESCRIPTION OF THE DRAWINGS

The invention will be described in more detail in the following text with reference to the attached drawings, in which:

FIG. 1 shows a schematic illustration of a ventilation installation in a motor vehicle;

FIG. 2 shows a detail of the fan motor from FIG. 1, in the form of an axial perspective;

FIG. 3 shows the detail from FIG. 2, in the form of a radial perspective; and

FIG. 4 shows a side section view through a fan motor from FIG. 1.

### DETAILED DESCRIPTION

Unless stated to the contrary, axial and radial details relate to a rotation axis of the fan motor. Identical or mutually corresponding elements have identical reference symbols in all the figures.

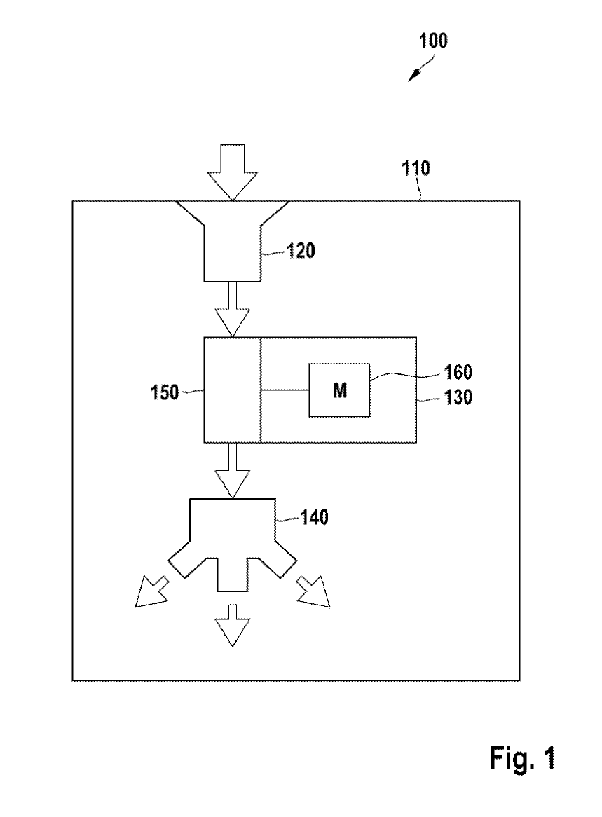

FIG. 1 shows a schematic illustration of an interior ventilation installation 100. A motor vehicle 110 comprises an induction section 120, a fan 130 and a distribution section 140. The fan 130 comprises a fan impellor 150 and a fan motor 160. The illustration in FIG. 1 does not include optional elements of the interior ventilation installation 100, such as filters, flaps, valves, heat exchangers, condensers and the like, which have no further relevance in the present context. The fan motor 160 causes the fan impellor 150 to rotate, thus resulting in air being sucked into the fan impellor 150 through the induction section 120 from outside the motor vehicle 110, and then being fed through the distribution section 140 into an interior of the motor vehicle 140. The induction section 120 and the distribution section 140 are frequently integrated in one section.

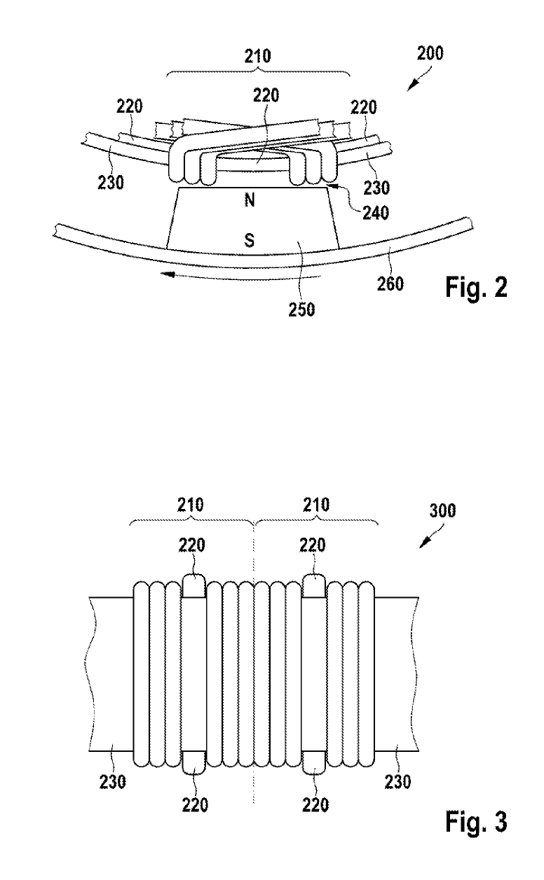

FIG. 2 shows a detail 200 of the fan motor 160 from FIG. 1 with air-cored coils, in the form of an axial perspective. A coil 210 is wound around a projection 220 and comprises three turns, whose axial sections are located, parallel to one another, on a circumference about the rotation axis of the fan motor 160. The visible ends of each turn are shown, not connected, in order to indicate that the turns can be connected in any desired manner to one another, to other turns or to electrical connections of the control circuit 410. A first concentric magnetic flux element 230, one section of which is illustrated, extends on a side of the coil 210 facing the rotation axis of the fan motor 160. The first magnetic flux element 230 is in the form of a hollow cylinder, overall. The first magnetic flux element 230 may, for example, be a stator core of any desired shape. For example, this may comprise a solid hollow-cylindrical element, a stack of laminates or a spirally wound flat wire. Elements or sections of the first magnetic flux element may be connected to one another in order to further reduce noise, for example by adhesive bonding, welding, riveting, clamping or screwing. In the center of the coil 210, the projection 220 covers the first magnetic flux element 230. There is no core between the turns of the coil 210 along the external circumference of the first magnetic flux element 230; the interior of the coil 210 is filled with air (“air-cored coil”).

A permanent magnet 250 extends in the radial direction, separated from the coil 210 by an annular gap 240. The ratio of the sizes of the permanent magnets 250 with respect to the coil 210 is not to scale. The number of coils 210 in the fan motor 160 may differ from the number of permanent magnets 250, for example 12 coils 210 and 11 or 13 permanent magnets 250. The permanent magnet 250 is magnetically radially aligned, in which case, as illustrated, the magnetic north pole may be on the inside or else on the outside. On its side facing away from the annular gap 240, the permanent magnet 250 rests on a second magnetic flux element 260, one section of which is illustrated. Overall, the second magnetic flux element 260 has a hollow-cylindrical shape. Like the first magnetic flux element 230, it may consist of a plurality of elements or of solid material and, for example, may be rolled, thermoformed, deep-drawn or turned from a tube (pushed off).

The figure does not show further coils 210 on both sides of the coil 210 that is illustrated, nor further permanent magnets 250 on both sides of the permanent magnet 250 that is illustrated. Adjacent elements may rest on one another, and adjacent permanent magnets may have mutually opposite magnetic alignments.

FIG. 3 shows a further detail view 300 of two coils 210 from FIG. 2 of the fan motor 160 from FIG. 1, in the form of a radial view. The permanent magnet 250 illustrated in FIG. 2 and the second magnetic flux element 260 are not illustrated in FIG. 3. The coils 210 are each wound around mutually opposite projections 220. Each of the coils 210 comprises three turns, with adjacent coils 210 being connected directly to one another. The axial sections of the turns of the coils 210 are arranged parallel to one another along the outer surface of the first magnetic flux element 230. The area in the interior of each coil 210, which is surrounded by the respective innermost turns, is filled with air; in other refinements, it is also possible to use a different magnetically neutral material, for example a synthetic resin such as polyester or epoxy.

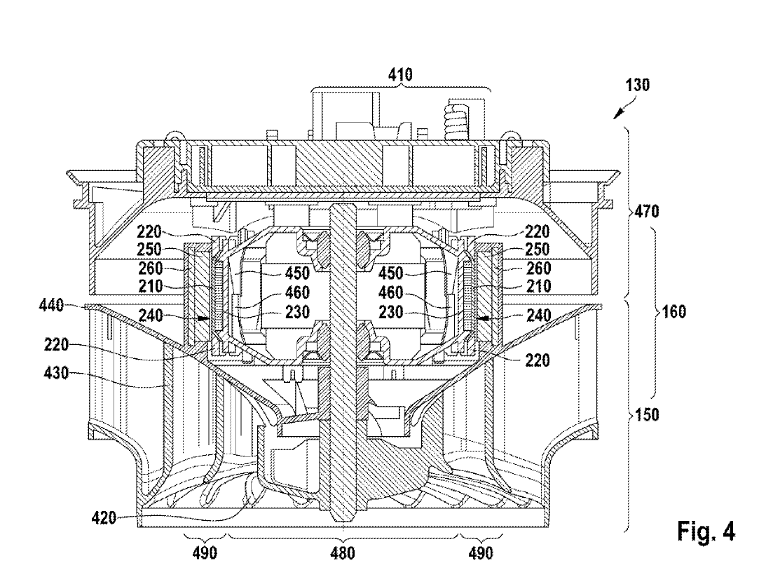

FIG. 4 shows a side section view through the fan 130 from FIG. 1. The fan 130 comprises the fan impellor 150, the fan motor 160, and an attachment flange 470 which holds the control circuit 410. The control circuit 410 is designed to activate and deactivate the coils 210 in a specific sequence during operation, in order to achieve a predetermined rotation speed for the fan motor 160. The actual rotation speed of the fan motor 160 can be determined by detecting an induced voltage, which is induced in unactivated coils 210 by the permanent magnets moving past them. Since no such voltage is induced when the fan motor 160 is stationary, there is no need to detect the actual rotation speed initially during a starting phase of the fan motor 160, and a predetermined activation sequence of the coils 210 can be used until the fan motor 160 has reached a sufficiently high rotation speed in order to carry out rotation-speed regulation.

The fan impellor 150 comprises suction blades 420 for sucking air in axially, outlet-flow blades 430 for the air which has been sucked in to flow out radially, and a deflection element 440 for deflection of the air which has been sucked in to the outlet-flow blades 430.

The deflection element 440 is connected in a rotationally stable manner to the suction blades 420 and to the outlet-flow blades 430. Furthermore, the deflection element 440 is fitted with a rotor 490 of the fan motor 160 in the form of the permanent magnets 250 and the second magnetic flux element 260. A stator 480 of the fan motor 160 comprises a winding former, which is formed from a first part 450 and a second part 460 and is fitted with the first magnetic flux element 230 and the coils 210. Each of the parts 450, 460 of the winding former has projections 220 for fixing the coils 210. The annular gap 240 extends between the coils 210 and the permanent magnets 250. The attachment flange 470 bears the stator 480 of the fan motor 160.

On an upper section, the attachment flange 470 is designed such that it can bear the fan 130 for example in an appropriate cutout in one wall of a ventilation section. The fan 130 may be removable from the cutout as a complete unit in the axial direction.

The described fan motor 160 is able to cover a broad rotation-speed range with a low to medium torque, and is therefore particularly suitable for use in the fan 130. Its low mass and its low tendency to produce noise qualify the fan motor 160 in a particular manner for use in the interior ventilation installation 100 of a motor vehicle 110.

In comparison to a conventional fan motor with the same drive power, a considerable weight saving can additionally be achieved, since there is no need to increase the rotation mass of the fan motor 160 for smooth-running stabilization purposes, or to operate the fan motor 160 permanently below its design performance, in order to avoid noise. In the case of a test example of a described fan motor 160, a weight of 400 g could be achieved, while a conventional fan motor with a comparable output power would have a weight of 880 g.

1. A fan (130) for an interior ventilation installation (100) for a motor vehicle (110) having a fan motor (160) which comprises
a first part (480, 490) having a multiplicity of radially aligned coils and
a second part (490, 480), which is borne such that it can rotate with respect to the first part and has a multiplicity of radially aligned permanent magnets (250);
with a concentric annular gap (240) being formed between the coils (210) on the first part and the permanent magnets (250) on the second part,
characterized in that
the coils (210) are air-cored coils.

2. The fan (130) as claimed in claim 1, characterized by a first magnetic flux element (230) for magnetic coupling of the coils (210) on a side of the coils facing away from the annular gap (240).

3. The fan (130) as claimed in claim 1, characterized in that a turns of the coils (210) rest on the first flux element (230) in a radial direction.

4. The fan (130) as claimed in claim 2, characterized by a second magnetic flux element (260) for magnetic coupling of the permanent magnets (250) on a side of the magnets facing away from the annular gap (240).

5. The fan (130) as claimed in claim 1, characterized in that the first part is a stator (480) and the second part is a rotor (490), which surrounds the stator (480).

6. The fan (130) as claimed in claim 5, characterized by a fan impellor (150) which is connected to the rotor (490).

7. The fan (130) as claimed in claim 6, characterized in that the fan impellor (150) has a half-axial design.

8. The fan (130) as claimed in claim 2, characterized by a winding former (450, 460) for fixing the first magnetic flux element (230).

9. The fan (130) as claimed in claim 8, characterized in that the winding former (450, 460) comprises two axially arranged parts (450, 460).

10. The fan (130) as claimed in claim 9, characterized in that each part (450, 460) of the winding former comprises a projection (220) for fixing one turn of one of the coils (210).

11. The fan (130) as claimed in claim 1, characterized by a control circuit (470), which is connected to the coils (210), for rotation-speed control without a sensor, based on excitation of a coil (210) through which no current is flowing.

12. A motor vehicle (110) comprising an interior ventilation installation (100) having a fan (130) as claimed in claim 11.
